(19) United States
(12) Patent Application Publication
(10) Pub. No.: US 2007/0290042 A1
(43) Pub. Date: Dec. 20, 2007

(54) Mailing label having a signature section and method of using same

(75) Inventors: Karen E. Schenck, Woodbridge, VA (US); Charles E. Bravo, Fairfax, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: UNITED STATES POSTAL SERVICE

(21) Appl. No.: 11/894,950

(22) Filed: Aug. 22, 2007

Related U.S. Application Data
(63) Continuation of application No. 10/956,977, filed on Sep. 30, 2004, now abandoned.
(60) Provisional application No. 60/568,239, filed on May 6, 2004.

(51) Int. Cl. G06K 7/10

(52) U.S. Cl. 235/462.01

(57) ABSTRACT

A mailing label includes an informational surface with a barcode section and a signature section. The mailing label can include an adhesive surface that is opposite of the informational surface. The signature section, being co-located on the same informational surface as the barcode section, can be simultaneously scannable with the barcode section by a single, portable scanning device. The mailing label can also include a special service descriptor section and an address section on the informational surface.

### CROSS-REFERENCE TO RELATED APPLICATIONS

This application claims the benefit of priority from U.S. Provisional Application No. 60/568,239 filed on May 6, 2004 to Schenck et al. and entitled “Mailing Label having a Signature Section,” which is fully incorporated herein by reference for all purposes.

### BACKGROUND OF THE INVENTION

1. Field of the Invention

The invention generally relates to a mailing label. More particularly, it relates to an electronically scannable mailing label having an integrated signature section.

2. Description of the Related Art

The United States Postal Service (USPS) is an independent establishment of the United States government that provides mail and package delivery, as well as other services to the public. The USPS is widely recognized as a safe and reliable means for sending and receiving mail and other items. With the advent and steady growth of electronic mail and electronic commerce, the physical mail stream will increasingly be utilized for sending and receiving bulk items, such as packages and the like. In an effort to ensure that mail is delivered not only to the right address, but also to the correct individual or entity at the right address, the USPS offers tracking of mailed items either separately from or in conjunction with many special service options.

Tracking of a mailed item can provide routing information, allowing an item to be sent from point A to point B. Tracking can also provide additional information, such as, for example, from where the item came, by whom and when the item was prepared, and where the item is located within the item delivery system. Tracking is typically accomplished by first affixing a scannable label (e.g., a barcode, etc.) to the mailed item. Then the label can be scanned at certain checkpoints along the transportation and delivery route. The final checkpoint in the route can be the final destination, or point of delivery, where the carrier can scan the item just prior to delivering it.

Special service options can include, for example, services such as delivery confirmation, signature confirmation, certified mail, registered mail, and others. These special service options can provide an added level of security, for example, by requiring a signature from the person who accepts the delivered item. These special service options can be combined with the tracking options.

After a carrier completes the final step of the tracking process described above, the recipient may sign a separate special services document indicating that the mailed item was received and noting by whom it was received. Unfortunately, this combination process of scans for tracking and signatures for special services can be costly, time consuming, complex and fraught with errors.

For example, the carrier must first complete the form that the recipient signs. Completing the form may include filling in an article number, a customer name, the carrier's name, a delivery date, a delivery address, and other information. This manual form-filling process can introduce errors. In addition, after receiving the recipient's signature, which can confirm the proper individual received the mailed item, the USPS must process the signature. Processing of the signature can include, for example, sending the signature document to an operator station for scanning, imaging, storage, and the like. These additional manual operations can also introduce errors.

What is needed, then, is a method and apparatus that minimizes the cost, time, complexity and errors involved with the current process of tracking a mailed item, and receiving and processing special service signatures.

### SUMMARY OF THE INVENTION

In some aspects of the invention, the present disclosure is directed to a mailing label having an informational surface that can include an indicia section and a signature section. The indicia section and the signature section can be scannable using a single pass of a scanning device.

In some aspects of the invention, the present disclosure is directed to a method of providing a tracking service and signature security service for a mailed item. The method can include providing a mailing label having an indicia section and a signature section, where the mailing label can be attachable to the mailed item. The method can also include obtaining a signature within the signature section from a recipient of the mailed item. Further, the method can include scanning both the indicia section and the signature section with a single data collection device.

Additional detail of the invention will be set forth in part in the description, which follows, and in part will be apparent to those skilled in the art from this disclosure, or may be learned by practice of the invention by those skilled in the art. The details of the invention can be realized and attained by means of the elements and combinations particularly pointed out in the appended claims.

It is to be understood that both the foregoing general description and the following detailed disclosure are exemplary and explanatory only and are not restrictive of the invention as claimed.

### BRIEF DESCRIPTION OF THE DRAWING

These and other aspects and features of the present invention will become apparent to those ordinarily skilled in the art upon review of the foregoing general description and the following detailed description of specific embodiments of the invention in conjunction with the accompanying drawing, wherein:

FIG. 1 illustrates an exemplary mailing label according to some embodiments of the present invention.

### DETAILED DESCRIPTION OF THE INVENTION

Embodiments of the present invention will now be described in detail with reference to the drawing, which is provided as an illustrative example of the invention so as to help enable those skilled in the art to practice the invention. Notably, the drawing and examples below are not meant to limit the scope of the present invention.

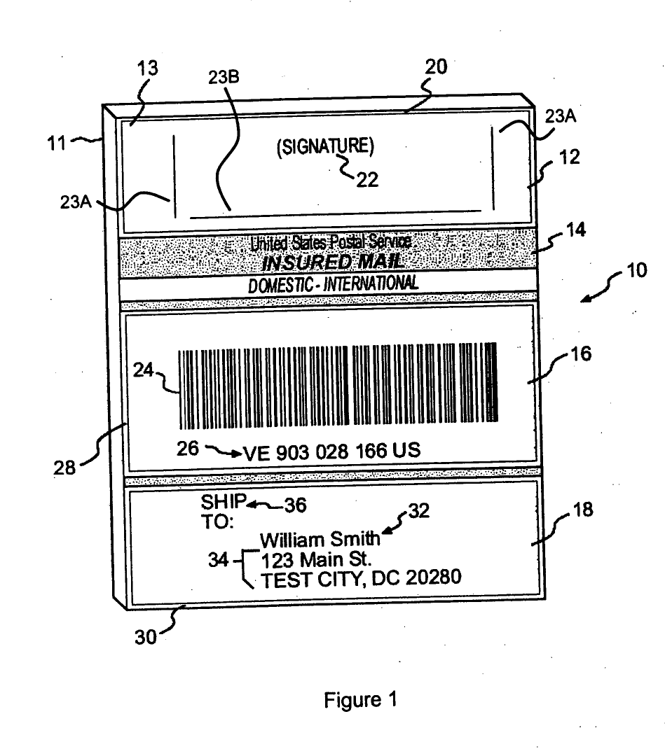

FIG. 1 illustrates an exemplary mailing label 10 according to some embodiments of the present invention. Mailing label 10 can include an adhesive surface 11 and can also include an informational surface 13 that is disposed on a side of the mailing label 10 that is opposite of the adhesive surface 11. For example, adhesive surface 11 may be considered the back side of mailing label 10, with informational surface 13 being the front side. As will be apparent to those skilled in the art from this disclosure, adhesive surface 11 can be omitted without deviation from the intended scope of the invention. In such a modification, some other means known in the art can affix the mailing label 10 to a mailed item (e.g., tape, glue, etc.). Informational surface 13 can include, for example, a signature section 12, a special service descriptor section 14, an indicia section 16, and an address section 18. It is contemplated that additional or fewer sections may be included on informational surface 13. It is further contemplated that the size, shape and configuration of the sections on information surface 13 may be altered or modified.

Signature section 12 can include a substantially blank space of varying size located, for example, on an uppermost portion of informational surface 13 relative to the remaining sections. Signature section 12 can extend horizontally from a first side edge of mailing label 10 to a second side edge opposite the first side edge. It is contemplated that signature section 12 may extend only a portion of the distance from the first side edge to the second side edge, that signature section 12 be at a position other than the uppermost portion of the mailing label 10, that signature section 12 may be vertically disposed on informational surface 13 relative to the remaining sections, and/or that signature section 12 may be left justified, centered, or right justified. Signature section 12 can include a border 20 surrounding signature section 12. It is also contemplated that border 20 can be absent from signature section 12 if desired.

Signature section 12 can include an instructional phrase 22 indicating, for example, the functional use of the section (e.g., the correct location of a recipient's signature, etc.). For example, instructional phrase 22 might include a phrase such as “SIGNATURE,” “SIGN HERE,” or any other suitable phrase. It is contemplated that instructional phrase 22 can be located anywhere within or around signature section 12. It is also contemplated that instructional phrase 22 can be absent from signature section 12 if desired. Along with, or apart from, instructional phrase 22, signature section 12 can include alignment bars 23A-B for aiding a recipient with signing signature section 12 and/or for aiding a data collection device in imaging signature section 12. It is contemplated, for example, that with a substantially horizontal signature section 12, alignment bars 23A-B can provide outside, vertical boundaries for the signature and/or a lower horizontal line for the signature. Of course, those skilled in the art will realize that alignment bars 23A-B are an optional part of the invention and can include any number, size and/or shape of such bars.

Special service descriptor section 14 can be located, for example, below signature section 12 and can describe the type of special service provided (i.e., purchased by a sender of the mailed item). The special services available can include, for example, delivery confirmation, insured mail, certified mail, registered mail, and others known in the art. Special service descriptor section 14 may extend horizontally from the first side edge of mailing label 10 to the second side edge. It is also contemplated that special service descriptor section 14 can extend only a portion of the distance from the first side edge to the second side edge, that special service descriptor section 14 can be vertically disposed on information surface 13 relative to the remaining sections, and that special service descriptor section 14 can be left justified, centered, or right justified. Special service descriptor section 14 can include a dark background and/or a border surrounding special service descriptor section 14. It is contemplated that special service descriptor section 14 may be eliminated altogether, with different special services being indicated on mailing label 10 by the use of different colored backgrounds, text inks, section borders, and the like. It is also contemplated that special service descriptor section 14 information can alternatively be included in another area of mailing label 10, such as indicia section 16.

Indicia section 16 can be located below special service descriptor section 14 and can extend horizontally from the first side edge of mailing label 10 to the second side edge. It is also contemplated that indicia section 16 can extend only a portion of the distance from the first side edge to the second side edge, that indicia section 16 can be vertically disposed on information surface 13 relative to the remaining sections, and that indicia section 16 can be left justified, centered, or right justified. Indicia section 16 can include a border 28 comprising a left side, a right side, an upper portion, and a lower portion. The left and right sides may have a line width thinner than a line width of the upper and lower portions. It is also contemplated that the line widths can be substantially equal, that the upper and lower portions can have a line width thicker than the line width of the left and right sides, or that border 28 can be absent, if desired.

Indicia section 16 can include a barcode 24, an alphanumeric code 26, or other identifier. Barcode 24 may be centrally located within indicia section 16 and scannable with a data collection device (not shown) The data collection device, for illustrative purposes, can be a personal digital assistant (PDA) type device that is capable of reading the information from barcode 24, as well as collecting a digital representation (e.g., scanned image, digital photo, TIFF file, JPEG file, PDF file, etc.) of the entire mailing label 10 or only certain sections of mailing label 10 (e.g., the indicia section with address section, the indicia section with signature section, the indicia section with address and signature sections, etc.). The PDA-type data collection device can then associate the collected digital image with the barcode information for later off-load into a database capable of reconciling the barcode information and associated digital representation.

Barcode 24 may be a one-dimensional barcode (i.e., data encoded in one dimension, for example, horizontal only) or a two-dimensional (i.e., data encoded in two dimensions, for example, both horizontal and vertical) barcode, both of which are known in the art. Barcode 24 can be linked to one or multiple pieces of information such as, for example, sender's name, sender's address, special service purchased, recipient's name, recipient's address, mailing facility, mailing date, mailing time, weight of item to be mailed, a tracking status, and other pieces of information known in the art. Alphanumeric code 26 may be related to barcode 24 and intended for human visual collection. For example, alphanumeric code 26 can be 13 digits in length. It is contemplated that Alphanumeric code 26 may include a greater or lesser number of digits and may be linked to the same or related pieces of information as barcode 24. It is also contemplated that alphanumeric code 26 may be linked to different pieces of information than those linked with barcode 24. It is further contemplated that alphanumeric code 26 may be absent, if desired, and only barcode 24 included in indicia section 16. It is also contemplated that barcode 24 may be absent, if desired, and replaced with a different means for linking mailing label 10 to the various pieces of information.

Address section 18 may be disposed on a lowermost section of informational surface 13 relative to the remaining sections and may extend horizontally from the first side edge of mailing label 10 to the second side edge. It is also contemplated that address section 18 may not extend entirely from the first side edge to the second side edge, that address section 18 may be vertically disposed on information surface 13 relative to the remaining sections, and that address section 18 may be left justified, centered, or right justified. Address section 18 may include a border 30 surrounding address section 18. It is also contemplated that border 30 may be absent if desired.

Address section 18 may include a name 32, which is part of an address 34, and an instructional phrase 36 designating the person listed under name 32 as the recipient of the mailed item. For example, instructional phrase 36 may include the phrase “SHIP TO,” “RECIPIENT,” “DELIVER TO,” or any other suitable phrase. It is contemplated that instructional phrase 36 can be located anywhere within or around address section 18. It is also contemplated that instructional phrase 36 can be absent if desired.

The disclosed mailing label 10 can be affixed, for example, to a United States Postal Service Priority Package, a United States Postal Service Express Mail Package, or any other suitable piece or parcel of mail. Mailing label 10 may reduce the cost, complexity, errors, and time associated with tracking a mailed item. Mailing label 10 may also reduce the cost, complexity, errors, and time associated with providing special service options by including signature section 12 on informational surface 13 of mailing label 10, which can be scannable by a carrier upon delivery of the mailed item.

In particular, as a mailed item reaches its final destination, it may be surrendered to the recipient for signature within signature section 12. The recipient's signature may signify, for example, that: the mailed item has reached its destination, the contents are in a desired condition, the correct person is receiving the mailed item, and/or other security measures have been satisfied. The recipient can receive the mailed item and sign his/her name within signature section 12 provided on mailing label 10.

The recipient's signature in signature section 12 and barcode 24 may then be scanned together by a single data collection device and stored together electronically in the resultant data collection file(s). The recipient's signature in signature section 12 and barcode 24 may be scanned separately or simultaneously. It is contemplated that the entire information surface 13 of mailing label 10 may be simultaneously captured in one pass of the data collection device and electronically stored in a single file. This electronic information may then be transferred to a data storage system and held, processed, manipulated and/or presented for viewing electronically as required. After scanning, the mailed item can then be returned to the recipient.

Mailing label 10 may reduce and/or eliminate the need for the carrier to fill out a separate signature-tracking document and perform the associated tasks of forwarding, scanning, imaging, and processing required by the separate signature document.

Although the present invention has been particularly described with reference to embodiments thereof, it should be readily apparent to those of ordinary skill in the art that various changes, modifications and substitutes are intended within the form and details thereof without departing from the spirit and scope of the invention. Other embodiments of the disclosed mailing label 10 will be apparent to those skilled in the art from consideration of the specification and practice of the invention disclosed herein. For example, a greater or lesser number of sections may be included on mailing label 10 and the sections may be in a different order. Mailing label 10 may also have a different shape than that in the present disclosure. Mailing label 10 may also include differing font styles, formats and colors, as well as background and border shapes, sizes and colors. It is intended that the specification and examples be considered as exemplary only, with a true scope and spirit of the invention being indicated by the following claims.

1. A mailing label, comprising:
an informational surface;
an indicia section disposed on the informational surface; and
a signature section disposed on the informational surface,
wherein the indicia section and the signature section are simultaneously scannable with a single, portable data collection device.

2. The mailing label of claim 1, wherein the indicia section includes a barcode.

3. The mailing label of claim 2, wherein the barcode is selected from a one-dimensional barcode and a two-dimensional barcode.

4. The mailing label of claim 2, wherein the barcode is linked to information related to at least one item selected from a set of items, the set of items including a sender's name, a sender's address, a recipient's name, a recipient's address, a date of mailing, a time of mailing, a mailing facility, a weight of the mailed item, a tracking status, and a type of mailing service.

5. The mailing label of claim 2, wherein the indicia section includes an alphanumeric code.

6. The mailing label of claim 1, wherein the indicia section includes an alphanumeric code.

7. The mailing label of claim 1, wherein the signature section is intended for a recipient's signature.

8. The mailing label of claim 1, wherein the signature section includes an instructional phrase.

9. The mailing label of claim 1, further including:
an address section disposed on the informational surface.

10. The mailing label of claim 9, wherein the address section includes at least one item selected from a set of items, the set of items including a recipient's name and a recipient's address.

11. The mailing label of claim 1, further including:
a service descriptor section disposed on the informational surface, the service
service descriptor section being indicative of a special mailing service.

12. The mailing label of claim 1, further including:
an adhesive surface on a side opposite the informational surface.

13. The mailing label of claim 1, wherein the single, portable data collection device is capable of:
reading identifying information from the indicia section;
digitally imaging the signature section; and
associating the digitally imaged signature section with the identifying information.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A mailing label, comprising:
an informational surface;
an indicia section having a barcode linked to information related to at least a first item selected from a set of first items, the set of first items including a sender's name, a sender's address, a recipient's name, a recipient's address, a date of mailing, a time of mailing, a mailing facility, a weight of the mailed item, a tracking status, and a type of mailing service, the indicia section being disposed on the informational surface;
a signature section intended for a recipient's signature, having an instructional phrase, and being disposed on the informational surface, wherein the indicia section and the signature section are simultaneously scannable with a single, portable data collection device;
an address section having at least one of a second item selected for a set of second items, the set of second items including a recipient's name and a recipient's address, the address section being disposed on the informational surface; and
an adhesive surface on a side opposite the informational surface.

27. The mailing label of claim 26, wherein the barcode is selected from a one-dimensional barcode and a two-dimensional barcode.

28. The mailing label of claim 26, wherein the indicia section includes an alphanumeric code.

29. The mailing label of claim 26, further including:
a service descriptor section disposed on the informational surface, the service descriptor section being indicative of a special mailing service.

30. The mailing label of claim 26, wherein the single, portable data collection device is capable of:
reading identifying information from the indicia section;
digitally imaging the signature section; and
associating the digitally imaged signature section with the identifying information.
